(19) United States
(12) Patent Application Publication
(10) Pub. No.: US 2018/0226732 A1
(43) Pub. Date: Aug. 9, 2018

(54) CONNECTION HOUSING WITH A CONNECTION DEVICE FOR CONDUCTORS

(71) Applicant: Weidmüller Interface GmbH & Co. KG, Detmold (DE)

(72) Inventors: Karlo STJEPANOVIC, Bielefeld (DE); Stephan FEHLING, Lage (DE); Constantin CLASSEN, Detmold (DE); Michael HERRMANN, Detmold (DE)

(21) Appl. No.: 15/761,703

(22) PCT Filed: Sep. 16, 2016
(86) PCT No.: PCT/EP2016/071926

§ 371 Date: Mar. 20, 2018

(30) Foreign Application Priority Data
Sep. 22, 2015 (DE) 202015105021.6

(51) Int. Cl. H01R 9/24; H01R 43/20; H01R 11/09; H01R 4/48

(52) U.S. Cl. CPC H01R 9/2416; H01R 43/20; H01R 4/48; H01R 11/09; H01R 9/2408

(57) ABSTRACT

A connection housing includes a connection housing rear wall, at least one open area, and at least one connection device for a conductor. The connection device preferably has at least individual conductor connections. Each individual conductor connection has a metal contact element, a spring support which is made of a non-conductive material such as synthetic plastic, and includes a base wall and a clamping spring. The spring support is inserted into the open area such that the base wall lies parallel to the rear wall of the connection housing at a distance therefrom. The base wall forms a guide for conductors to be inserted, and the base wall completely or partly closes the housing towards the outside in the region of the open area.

### CROSS-REFERENCE TO EARLIER APPLICATIONS

This application is a § 371 of PCT/EP2016/071926 filed Sep. 16, 2016. PCT/EP2016/071926 claims priority of DE 20 2015 105 021.6 filed Sep. 22, 2015. The entire contents of these applications are incorporated herein by reference.

### BACKGROUND OF THE INVENTION

The invention relates to a connection housing, and particularly to a terminal block or plug housing, having at least one connection device for conductors.

Such connection housings, particularly terminal block housings, often have the disadvantage of a relatively complex design. According to the invention, this design is made as simple as possible.

### SUMMARY OF THE INVENTION

The invention relates to a terminal block or a plug having a connection housing and at least one connection device. The connection housing includes a connection housing rear wall and at least one open area and at least one connection device for conductors, which have one or multiple individual conductor connections, each individual conductor connection including a metal contact element, a spring support made of a non-conductive material, preferably a synthetic plastic, a base wall and a clamping spring. The spring support is inserted into the open area such that the base wall lies parallel to the rear wall of the connection housing at a distance therefrom. The base wall completely or partially closes the housing towards the outside in the region of the open area.

The conductor connection of the connection housing is particularly well suited for preassembled insertion into a connection housing, particularly a terminal block housing, to be used as the only one or more conductor connections of the housing. The conductor to be inserted is enclosed by conductor guides, preferably on multiple sides. This makes connecting even fine-wire conductors very easy. In addition, the terminal block has a simple design and can be assembled in a simple and easy manner. Each spring support has a functional contour for holding the clamping spring on just one of its sides of the base wall. This is the side that is facing towards or positioned at the rear wall of the connection housing.

The rear wall of the spring support is preferably flush with a front wall of the housing to provide a narrow configuration.

According to a preferred embodiment, one of the clamping springs or the contact limb of the contact elements is disposed in a compact and secure manner between the base wall of the spring support and the rear wall of the housing.

One or more individual conductor connections are configured as direct plug connections. Each individual conductor connection preferably includes a single metal contact element, particularly one designed as a clamping ring having more than two sides, a single spring support made of a non-conductive material, particularly a non-conductive plastic, and a single clamping spring.

A plurality of the individual conductor connections can be configured one behind the other in the direction of the main extension on a busbar.

According to a preferred embodiment, each contact element has an L shape with a base limb and a contact limb.

Each spring support preferably has a U shape with the rear wall securely holding the contact spring. the spring support further has at least one side wall perpendicular to the rear wall and preferably includes a spring holding contour. The other side of the rear wall is preferably flat to close the connection housing towards the outside as flat as possible in the region of the spring support.

It also useful if the spring support and/or the contact element one or more mounting devices—particularly a form or snug fit device and/or a latching device—which are configured to interact with a corresponding mounting device on the connection housing, particularly the terminal block or plug housing.

The connection housing rear wall, the contact limb of the contact element, the clamping limb and the base wall of the spring support each form conductor guides, which lie below the associated conductor insertion opening in the connection housing, because in this way a conductor can be safely be inserted into the respective clamping site.

### BRIEF DESCRIPTION OF THE FIGURES

The invention will be described in greater detail below based on exemplary embodiments and with reference to the accompanying drawing, wherein other options and advantages of the invention will become apparent, in which

FIG. 1a-FIG. 1d are perspective views illustrating four steps in the assembly of a terminal housing with a connection device for conductors according to the invention;

FIG. 2a is a perspective view of an individual conductor connection with a busbar, a contact element, a clamping spring and a spring support;

FIG. 2b is a perspective view of a busbar with three individual conductor connections;

FIG. 3a is a perspective view of a further terminal housing and an associated connection device for conductors;

FIG. 3b is an internal view of the connection device of FIG. 3a; and

FIG. 4 is an exploded perspective view of a terminal housing and another connection device for conductors.

### DETAILED DESCRIPTION

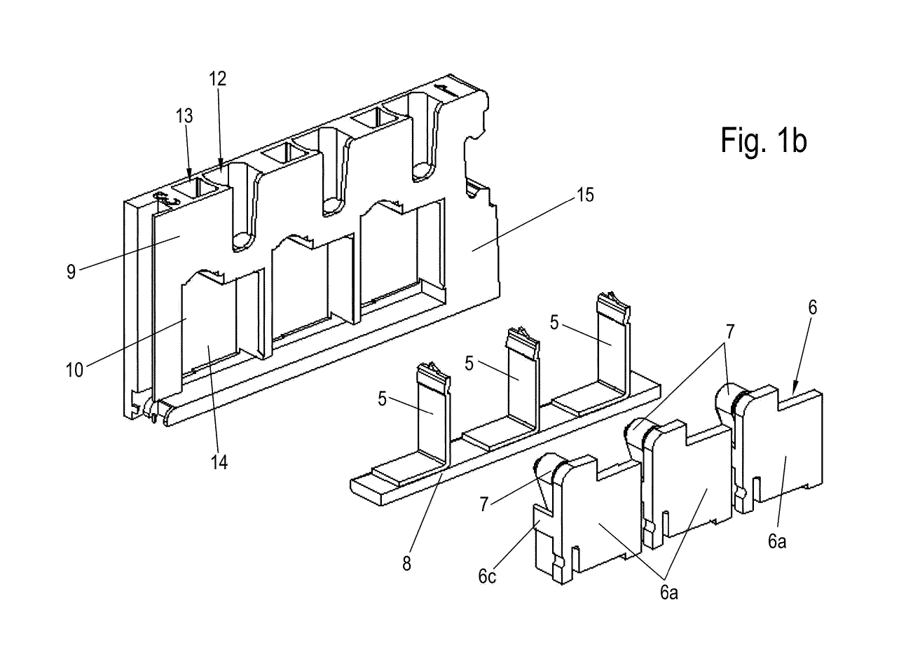

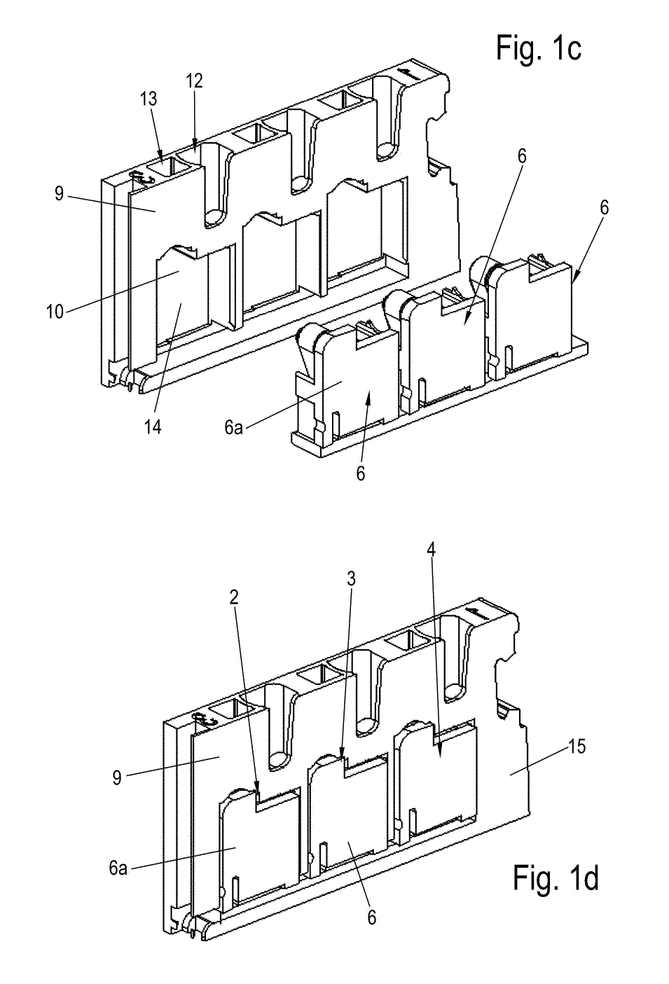

FIG. 2a shows a first embodiment of a connection device 1 for conductors according to the invention. This connection device 1 is configured as an individual conductor connection 2, which is fastened to a busbar 8 and provides a connection or electric contact with a conductor end (not shown). The connection device 1 of FIG. 2b shows three individual conductor connections 2, 3, and 4 which are fastened to a busbar 8 so that a total of three conductors can be connected.

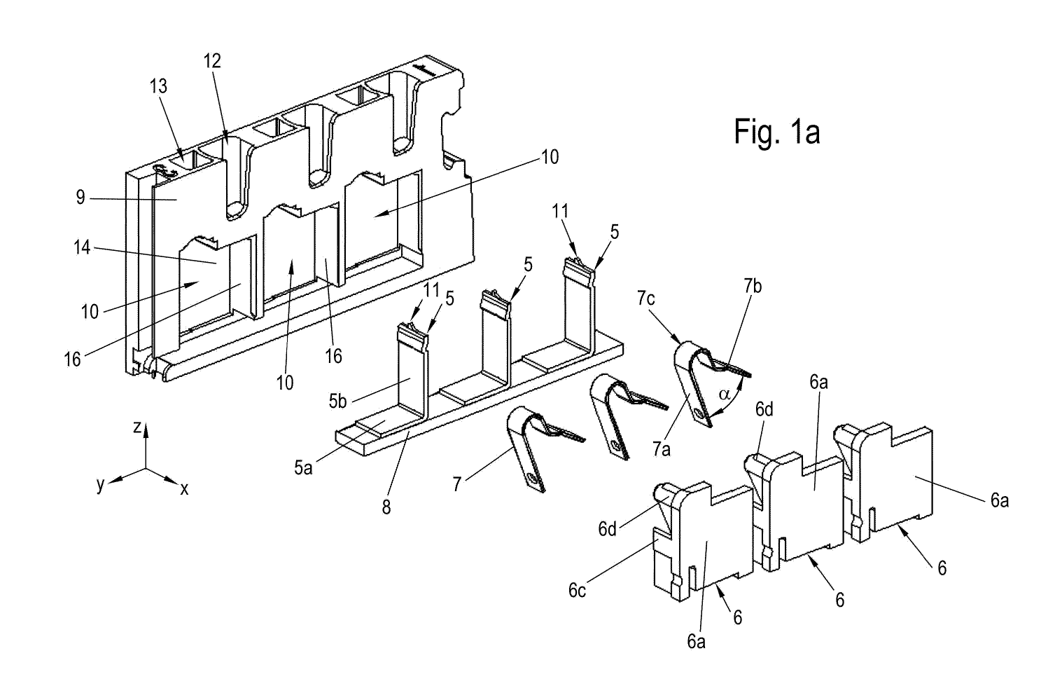

The individual conductor connections 2, 3, 4 are configured as direct plug connections or push-ins. Each of the individual conductor connections 2, 3, 4 of which three are shown in FIG. 1a includes a metal contact element 5 or a clamping ring, a spring support 6 made of a non-conductive material such as synthetic plastic, and a clamping spring 7. In this way, a self-contained individual conductor connection 2 is formed which can preferably be combined with other individual conductor connections 3, 4 to provide multiple conductor connections arranged in series. It should be understood that three conductor connections are shown by way of example only and that any number of conductor connections may be provided.

Each contact element 5 has an L shape with a base limb or leg 5a and a contact limb 5b. The base limb 5a is used to fasten the respective contact element 5 on a busbar 8. This is preferably done by soldering or welding the base limb 5a to the busbar 8. The two or more contact elements 5 are arranged in a longitudinal extension direction Y of the busbar 8. Since the contact elements 5 are not integral with the busbar 8 but are fastened to it, they can be arranged in close succession one behind the other in the longitudinal extension direction Y of the busbar 8. In particular, their distance in the Y direction can be much smaller than the longitudinal extension of the spring supports 6. It is also conceivable to punch the contact limbs 5b out of the material of the busbar 8 and to bend them outwards not shown, or to provide clamping rings with a geometry other than an L shape as contact elements 5.

The spring supports 6 have a U shape in top view as shown in FIG. 2, with a base wall 6a and two side walls 6b, 6c extending vertically from the base wall. A spring holding contour 6d also extends perpendicular to the base wall 6a.

The spring support 6 and/or the contact element 5 further include one or more mounting devices—particularly form or snug fit devices and/or latching devices—which are configured to interact with corresponding mounting devices—such as form fit devices and/or latching devices as well—on a receiving element such as a connection housing 9, and in particular a terminal block or plug housing. The housing 9 is designed for joining in the X direction—referred to as the joining direction.

The connection housing 9 contains one or more open spaces 10 for inserting one or more spring supports 6 and can be designed in various ways as will be explained in more detail below.

The clamping spring 7 shown in FIG. 2a is substantially V shaped and includes a support limb or leg 7a and a clamping limb 7b arranged at an acute angle 10°<α<90° to the support limb. The support limb 7a and the clamping limb 7b are connected via a spring back 7c.

The spring supports 6 are configured to be placed onto the clamping springs 7. The spring back 7c extends over and engages the spring holding contour 6d of the spring support 6. The support limb 7a of the clamping spring preferably lies between the spring holding contour 6d and one of the two side walls 6c. The spring holder contour 6d is preferably oriented obliquely at a spring angle of preferably 0<β60° to the conductor insertion direction Z. The spring holder contour 6d is further preferably of a length that it extends over the entire length of the support limb 7a of the clamping spring 7. This makes the clamping spring 7 easy to preassemble. The spring holder contour 6d can also form a stop for an opening movement of the clamping limb 7b of the clamping spring 7. The spring holder contour 6d can also be formed of multiple individual sections. The clamping limb 7b preferably rests against the contact limb 5b in a state in which it does not contact a conductor. In the contacting state, it presses a conductor against the electrically conductive contact limb 5b.

It is preferred that one mounting device is configured as one or more projections 11 on the free end of one of the contact elements 5 or on the free ends of the contact limbs 5b of multiple contact elements S. One or more corresponding latching counterparts, for example one or multiple locking edges, at which the projections 11 on the contact elements 5 can be interlocked are then formed in the connection housing 9.

In addition, form fit devices such as pegs are formed on the connection housing 9 and corresponding form fit devices are formed as holes on the spring support 9 (not shown), which alone or in addition fasten the individual conductor connections to the connection housing 9.

A single clamping spring 7 can preferably be placed onto each of the spring supports 6 and preassembled. Another option is a spring support 6 that extends continuously across multiple individual conductor connections (not shown) on which multiple clamping springs 7 are arranged one behind the other in one row in the Y direction. In FIG. 2a, three spring supports 6 would be integrally connected, for example. Since the clamping springs 7 are arranged in a row one behind the other and since the conductor connections thus are offset in the Y direction, a string of three individual conductor connections, each of which allows the connection of one conductor and in total of multiple conductors at separate clamping sites, is still considered within this embodiment.

The one or more spring supports 6 with one or more clamping springs 7 can be placed on top of the busbar 8 using the contact element 5 which is fastened thereon or integrally molded thereto. The contact element 5 engages between the clamping limb 7b of the respective clamping spring 7 and the one side wall 6b of the spring support 6, and the support limb 7a rests on the other side wall 6c of the spring support 6. This means that the support limb 7a of the clamping spring 7 preferably rests on an element made of plastic and absorbs a portion of the contact forces. It is also conceivable that it rests on a metallic element, for example a busbar limb or a clamping ring limb of a contact element designed as a clamping ring. Resting on the plastic spring support 7 is particularly cost-effective and simple.

The individual conductor connections 2, 3, 4 are preassembled on the busbar 8 and inserted into the connection housing 9 such as a terminal block with at least one open area 10. This open area 10 in the terminal block housing is dimensioned such that the busbar 8 can be inserted, on which busbar one or preferably a plurality of individual conductor connections 2, 3, 4 are arranged in a row one behind the other, each preferably including a spring support 6, one of the clamping elements 5, and one of the clamping springs 7. Furthermore, one or more conductor insertion openings 12 and one or more openings 13 for pushbuttons or screwdrivers or the like, which are used to open the clamping site between the respective clamping limb 7b and the respective contact limb 5b, can be provided in the connection housing, particularly in the terminal block housing 9.

During assembly, the clamping springs 7 are placed onto the spring supports 6 shown in FIGS. 1a and 1b. Then the spring supports 6 with the clamping springs 7 are placed on the busbar 8 shown in FIG. 1c with which the contact elements 5 were previously fastened or molded.

In this way, the busbars 8 are easily preassembled with conductor connections as shown in FIG. 1c and can be inserted as a preassembled unit into the terminal block housing 9, where the mounting devices on the connection housing and on one or more spring supports 6 or contact elements 5 interact as shown in FIG. 1d.

The individual conductor connections 2 are inserted such that a connection housing rear wall 14 and the spring support base wall 6a are arranged parallel in the region of the open areas 10, wherein the contact elements 5 and the contact springs 7 lie between these two walls 14, 6a. The connection housing 9 includes wall sections 16 perpendicular to the connection housing rear wall 14 which separate and laterally define the open areas. The connection housing 9 and the spring support 6 thus form a closed rectangular geometry in this region when viewed from the top. The clamping spring 7 and a conductor to be connected are thus in a well-protected position. This allows the connection of fine-wire conductors, since the connection housing rear wall 14, the contact limb 5b of the contact element 5, the clamping limb 7b and the base wall 6a of the spring support 6 form conductor guides which make inserting the respective conductor into the clamping site easier. The base wall 6a is completely or at least almost flush with the front wall 15 of the connection housing. This makes it possible to form a completely or almost completely closed wall from the front wall 15 and one or more of the base walls. Only the gap in which the busbar 8 is seated is not closed in the region of the front wall 15 or the base walls 6a. Each base wall 6a advantageously forms a conductor guide towards the side of the front wall 15.

The conductor guides each lie in the Z direction below the conductor insertion opening 12 in the connection housing 9.

The number of individual conductor connections of the terminal block can easily be varied. Also, multiple busbars 8 with conductor connections can be inserted in the connection housing 9, particularly the terminal block housing.

It is also possible to connect the spring supports 6 for multiple individual conductor connections 2, 3, 4 directly and integrally into one piece. In this case, the rear wall extends continuously across a plurality of the spring supports 6.

In the terminal block housing 9, conductor connection mounting devices can be provided in the region of the open areas 10 which interact with corresponding conductor connection mounting devotes on the conductor connections—that is, on the clamping spring, the spring support 6, the contact element 5, and/or the busbar 8.

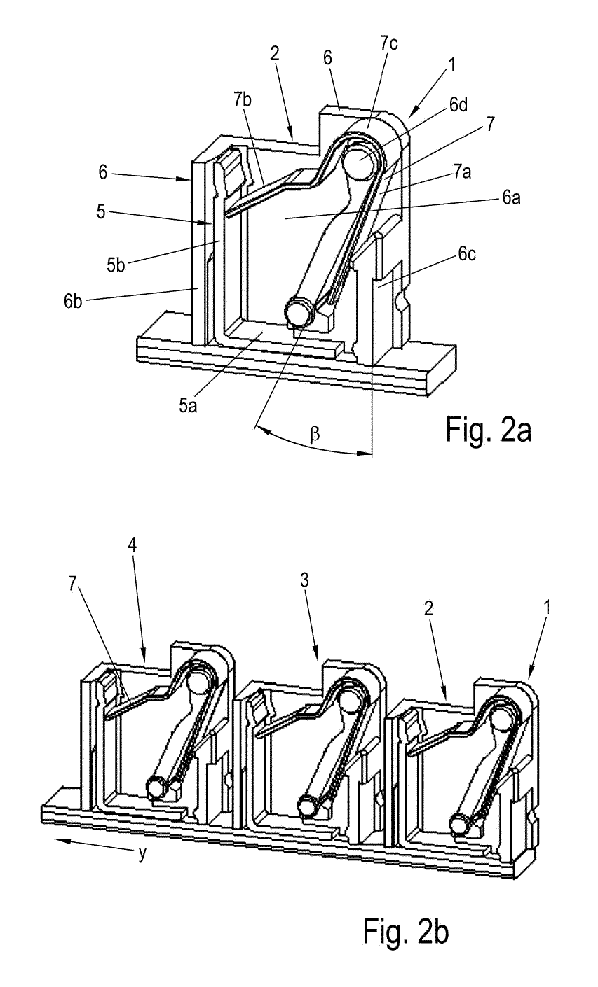

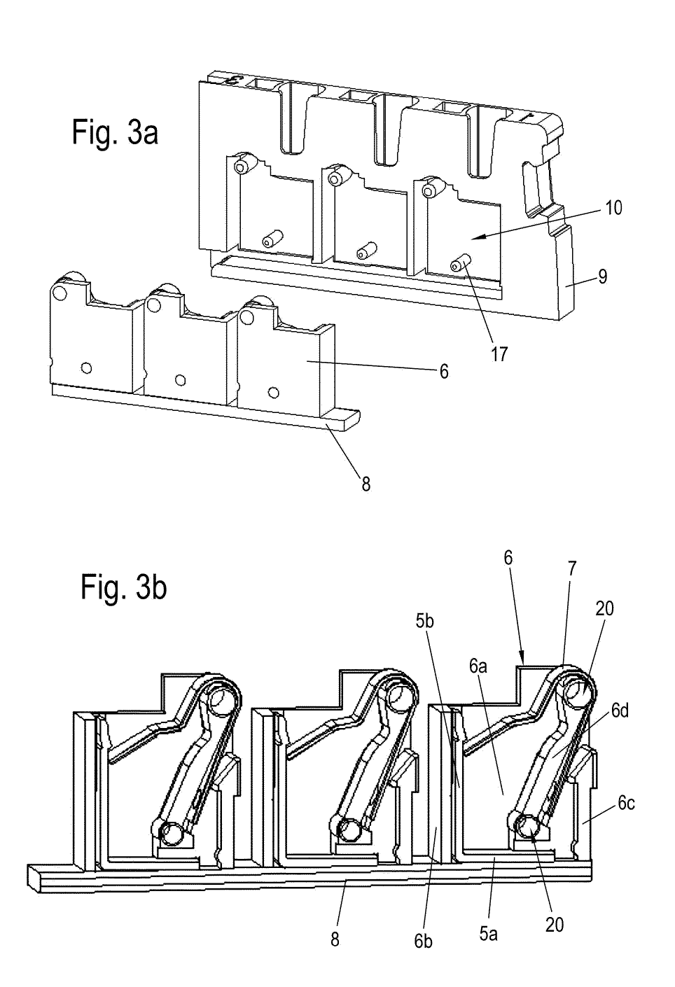

According to a preferred embodiment, pegs 17 can be provided in the region of the open areas 10 in the terminal (block) housing 9, for example on the housing rear wall 14 as shown in FIG. 3a, which interact in a clamping or latching manner with corresponding holes 20 in pegs in the spring holding contour 6d of the spring supports 6 as shown in FIG. 3b.

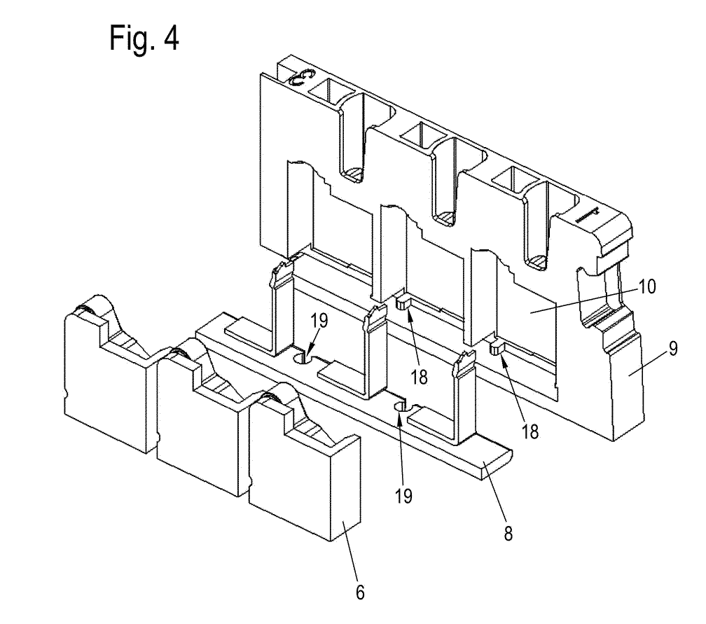

Alternatively, puzzle-like projections 18 can protrude from the housing rear wall 15 as shown in FIG. 4, which projections engage respective recesses 19 in the edge of the busbar 8. In FIG. 4, the busbar 8 and the contact elements 5 are preassembled, and the spring supports 6 are preassembled with the clamping springs 7. These modules are assembled and then installed in the housing 9. It is also possible to install them there one after the other. In addition, projections 11 are formed on the free ends of the contact elements 5 in this embodiment as well. Multiple locking edges where the projections 11 on the contact elements 5 can interlock are formed in the connection housing 9.

It is also possible to connect the spring supports 6 for multiple individual conductor connections in series directly and integrally into one piece. In this case, the base wall extends continuously across a plurality of the spring supports 6 not shown, such that a plurality of clamping springs can be arranged thereon.

1-22. (canceled)

23. A connection device for at least one electrical conductor, comprising
(a) a housing including rear wall and a front wall spaced from and parallel to said rear wall, said housing front wall containing at least one open area; and
(b) at least one connection device for a conductor arranged within said housing, each connection device including
(1) a spring support formed of a non-conductive material and including a base wall;
(2) a metal contact element arranged within said spring support; and
(3) a clamping spring mounted on said spring support, said spring support being arranged in one open area of said housing with said base wall being arranged parallel with and spaced from said housing rear wall, said base wall at least partially closing said housing in the region of the open area.

24. A connection device as defined in claim 23, wherein said spring support base wall is arranged flush with housing front wall.

25. A connection device as defined in claim 23, wherein said clamping spring is arranged between said spring support base wall and said housing rear wall.

26. A connection device as defined in claim 23, wherein said contact element includes a contact limb arranged between said spring support base wall and said housing rear wall.

27. A connection device as defined in claim 23, wherein each connection device is configured as a direct plug connection.

28. A connection device as defined in claim 23, wherein each connection device includes one of a metal contact element and a clamping ring, a single spring support made of a non-conductive synthetic plastic material, and a single clamping spring.

29. A connection device as defined in claim 23, wherein a plurality of connection devices are provided and configured one behind the other along the length of a busbar.

30. A connection device as defined in claim 23, wherein each contact element has an L shape and includes a base limb and a contact limb.

31. A connection device as defined in claim 23, wherein each contact element is designed as a one-piece unit integral or connected with a busbar.

32. A connection device as defined in claim 23, wherein said spring support has a U shape configuration and at least one side wall which extends perpendicular to said spring support base wall.

33. A connection device as defined in claim 32, wherein said spring support includes a contour portion which extends perpendicular to said spring support base wall.

34. A connection device as defined in claim 33, wherein said spring support contour portion supports said clamping spring and wherein said spring support includes at least one side wall on a side extending toward said housing rear wall.

35. A connection device as defined in claim 23, wherein each connection device includes a mounting device which interlocks each connection device within said housing.

36. A connection device as defined in claim 35, wherein at least one of said spring support and said contact element include at least one mounting device and wherein said housing includes a further mounting device, said mounting devices cooperating via one of a snug fit and a latch to connect said connection device with said housing.

37. A connection device as defined in claim 34, wherein said clamping spring has a V shape and includes a support limb and a clamping limb arranged at an acute angle 10°<α<90° relative to said support limb, said support limb and said clamping spring being connected via a spring back portion.

38. A connection device as defined in claim 37, said spring back portion extends over and engages said spring support contour portion.

39. A connection device as defined in claim 38, wherein said clamping spring support limb is arranged between said spring support contour portion and a spring support side wall and rests on said spring support side wall.

40. A connection device as defined in claim 37, wherein said spring support contour portion is arranged at a spring angle of preferably 0<β60° relative to a conductor insertion direction.

41. A connection device as defined in claim 37, wherein said spring support contour portion has a length extending over the entire length of said clamping spring support limb.

42. A connection device as defined in claim 36, wherein said connection device mounting device comprises at least one projection on a free end of said contact element and wherein said housing mounting device includes an edge which receives and interlocks with said projection.

43. A connection device as defined in claim 37, wherein said housing contains at least one conductor opening for receiving a conductor to be connected, said housing rear wall, said contact element contact limb, said clamping spring clamping limb and said spring support base wall defining guides which extend below a conductor opening for guiding a conductor being inserted into said housing.

44. A terminal block including a connection device as defined in claim 23.
